(19) United States
(12) Patent Application Publication
(10) Pub. No.: US 2015/0185954 A1
(43) Pub. Date: Jul. 2, 2015

(54) ELECTRONIC DEVICE WITH MULTI-FUNCTION SENSOR AND METHOD OF OPERATING SUCH DEVICE

(71) Applicant: J-Metrics Technology Co., Ltd., Taipei City (TW)

(72) Inventor: JER-WEI CHANG, HSINCHU CITY (TW)

(21) Appl. No.: 14/583,384

(22) Filed: Dec. 26, 2014

(30) Foreign Application Priority Data
Dec. 31, 2013 (TW) 102149375

(51) Int. Cl. G06F 3/041; G06K 9/00

(52) U.S. Cl. CPC G06F 3/0416; G06K 9/00013

(57) ABSTRACT

An electronic device comprises a body and a display, a finger sensor and a processing module disposed on the body. The processing module electrically connected to the finger sensor and the display cooperates with the display and the finger sensor to operate in a first mode and a second mode. In the first mode, the finger sensor senses a biometrics characteristic of a finger of a user to obtain a biometrics characteristic signal, and the processing module performs an enrollment or authentication procedure according to the biometrics characteristic signal. In the second mode, the finger sensor senses a touch operation of the finger of the user to obtain a touch signal, and the processing module controls an operation of an operation system or an application program loaded into the processing module according to the touch signal. A method of operating the electronic device is also disclosed.

This application claims priority of No. 102149375 filed in Taiwan R.O.C. on Dec. 31, 2013 under 35 USC 119, the entire content of which is hereby incorporated by reference.

### BACKGROUND OF THE INVENTION

1. Field of the Invention

The invention relates to an electronic device and an operating method, and more particularly to an electronic device with multi-function sensor and a method of operating such device.

2. Related Art

A mobile electronic device, such as a mobile phone, a tablet computer or the like, has at least one switch or button for enabling or waking up this electronic device, and the switch or button is also gradually changed from the mechanical button to the capacitive touch switch. The advantage of the capacitive touch switch is free of the wearing problem of the mechanical button, caused by the multiple pressing operations, and is free of the opening, which is necessary for the mechanical button, when designing the electronic device. Thus, the overall design feeling can be maintained and the more beautiful outlook can be obtained. This is why the capacitive touch switch is getting more and more popular.

Furthermore, the electronic apparatus with the fingerprint sensor can provide the fingerprint recognition function, and thus provide a more robust identification authentication method than the password protection for the data confidentiality, and thus have the high business opportunity in the market. However, under the restriction of the design principle of the sensing mechanism, the conventional fingerprint sensor must be installed in the opening of the electronic apparatus to facilitate the pressing or sweeping operation of the user's finger. The installation of the fingerprint sensor affects the outlook of the electronic apparatus. This drawback is similar to that of the mechanical button.

When the mobile electronic device is installed with the fingerprint sensor, the spent cost gets higher, and the fingerprint sensor is usually used with a single function for sensing only the fingerprint. The capacitive touch switch for controlling this electronic device still needs to operate independently based on the conventional design. Such the independent hardware operation wastes the cost, and occupies the considerable space. Consequently, the desired functions of the fingerprint sensor cannot be further executed, and this is a great waste for the design of the electronic device.

### SUMMARY OF THE INVENTION

It is therefore an object of the invention to provide an electronic device with a multi-function sensor and an operating method thereof, wherein a finger sensor of the electronic device can sense the finger's biometrics characteristic, and can function as a button for controlling operations of the electronic device.

To achieve the above-identified object, the invention provides an electronic device comprising a body, and a display, a finger sensor and a processing module, all of which are disposed on the body. The processing module electrically connected to the finger sensor and the display cooperates with the display and the finger sensor to operate in a first mode and a second mode. In the first mode, the finger sensor senses a biometrics characteristic of a finger of a user to obtain a biometrics characteristic signal, and the processing module performs an enrollment or authentication procedure according to the biometrics characteristic signal. In the second mode, the finger sensor senses a touch operation of the finger of the user to obtain a touch signal, and the processing module controls an operation of an operation system or an application program loaded into the processing module according to the touch signal.

The invention further provides an operating method of an electronic device. The electronic device comprises a display, a finger sensor and a processing module. The processing module is electrically connected to the finger sensor and the display. The operating method comprises the steps of: receiving a trigger signal by the processing module, and switching from a sleep mode to a biometrics characteristic authentication mode; displaying an indication on the display to request a user to perform a biometrics characteristic authentication and utilize the finger sensor to sense a biometrics characteristic of a finger of the user to obtain a biometrics characteristic signal in the biometrics characteristic authentication mode, wherein the processing module performs the biometrics characteristic authentication according to the biometrics characteristic signal, and enters a detection mode after passing the biometrics characteristic authentication; and sensing, by the finger sensor, a touch operation of the finger of the user to obtain a touch signal, and controlling, by the processing module, an operation of an operation system or an application program loaded into the processing module according to the touch signal in the detection mode.

The invention further provides an operating method of an electronic device. The electronic device comprises a display, a finger sensor and a processing module. The processing module is electrically connected to the finger sensor and the display. The operating method comprises the steps of: executing a biometrics characteristic authentication application program by the processing module to enter a biometrics characteristic authentication mode; utilizing the finger sensor to sense a biometrics characteristic of a finger of a user to obtain a biometrics characteristic signal in the biometrics characteristic authentication mode, wherein the processing module performs a biometrics characteristic authentication according to the biometrics characteristic signal, and leaves the biometrics characteristic authentication mode and enters a detection mode after passing the biometrics characteristic authentication; and sensing, by the finger sensor, a touch operation of the finger of the user to obtain a touch signal, and controlling, by the processing module, an operation of an operation system or an application program loaded into the processing module according to the touch signal in the detection mode.

With the above-mentioned electronic device, the advanced and maximum effectiveness of the finger sensor can be obtained so that the finger sensor functions as the button or key. In addition, the combination of the button and the finger sensor also make the overall electronic device become more concise and beautiful.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 is a schematic top view showing an electronic device according to a preferred embodiment of the invention.

FIGS. 2A and 2B are partial top views showing examples of the electronic device of FIG. 1.

FIG. 2C is a partial bottom view showing one example of the electronic device of FIG. 1.

FIG. 2D is a partial cross-sectional view showing the electronic device of FIG. 2C.

FIG. 2E is a partial cross-sectional view showing another example of the electronic device of FIG. 2D.

FIG. 2F is a partial cross-sectional view showing still another example of the electronic device of FIG. 2D.

FIGS. 3A and 3B are flow charts showing two examples of the operating method of the electronic device according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

In the embodiment of the invention, the finger sensor is configured to have two functions, wherein the first function is to sense fine biometrics characteristics of a finger, such as the fingerprint or vein image, while the second function is to sense whether a touch of the finger is present, or even whether the proximity of the finger is present, so that the single sensor may have the multiple functions. In addition, when the multiple functions work in conjunction with the firmware/software functions, the use condition can be intelligently switched, or the sensor may function as the biometrics identification or function as a switch button for detecting whether the touch of the finger is present. Thus, the electronic device can execute multiple sensing functions with one single hardware device, thereby saving the cost and simplifying the hardware design.

The multi-function sensing electronic device of the invention provides at least two functions. Of course, based on the extension of the invention, other functions developed based on the similar concept are also deemed as falling within the scope of the invention. For example, the first function is to provide the fingerprint or vein image sensing function, while the second function is provide the button function. Using the operation state of one or more than one of the sensing members of the finger sensor can provide the button function, and achieve the power-saving effect. Using the button function provided by the sensing members of the finger sensor can trigger the fingerprint sensing function of the finger sensor. For example, when some of the sensing members are triggered, all the sensing members can be triggered to provide the fingerprint sensing function so that the user can utilize the fingerprint authentication to enable the access right of the electronic device. The invention can be widely applied to the electronic device, such as a mobile phone, a tablet computer, a smart watch or a notebook computer, which comprises a fingerprint sensor and needs the biometrics characteristic authentication.

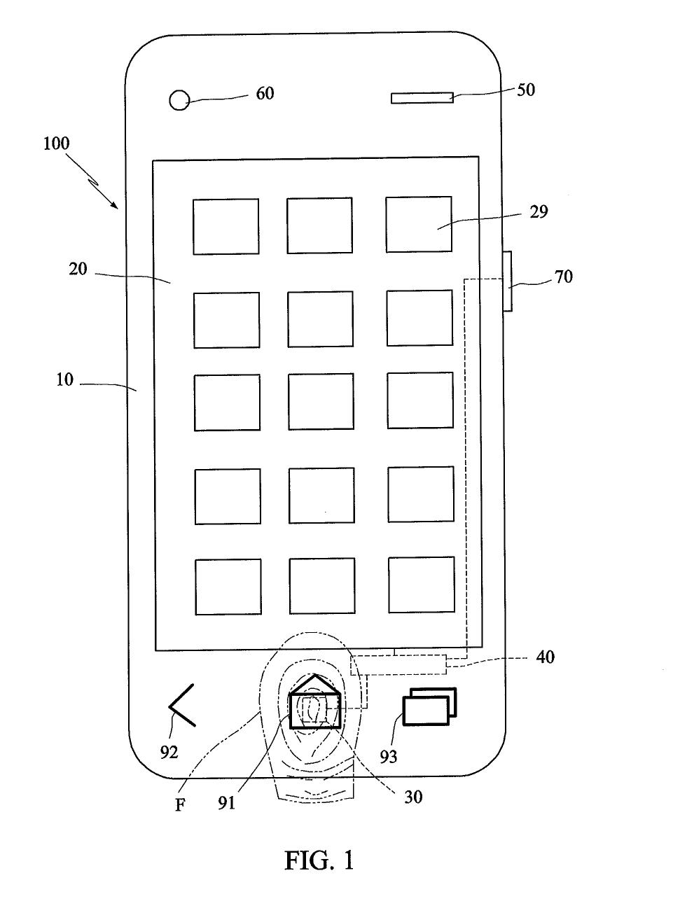

FIG. 1 is a schematic top view showing an electronic device 100 according to a preferred embodiment of the invention. Referring to FIG. 1, the electronic device 100 of this embodiment comprises a body 10, a display 20, a finger sensor 30 and a processing module 40.

The body 10 may comprise a casing and/or housing of the electronic device. The display 20 disposed on the body 10 displays information, such as texts, pictures, or a touch icon 29 corresponding to a particular application program. The finger sensor 30 is disposed on the body 10, and disposed in a hidden manner in one embodiment. For example, the finger sensor 30 is hidden under a glass panel or a certain mechanism (switch mechanism, fastening mechanism, covering mechanism or the like). In another embodiment, the finger sensor 30 may be exposed.

The finger sensor 30 may be a sweep-type fingerprint sensor for sensing the fingerprint of a finger F sweeping across the fingerprint sensor in a first mode, and may be an area-type fingerprint sensor for sensing the fingerprint of the finger F stationarily placed on the fingerprint sensor in the first mode.

The processing module 40 is disposed on the body 10, is electrically connected to the finger sensor 30 and the display 20, and cooperates with the display 20 and the finger sensor 30 to operate in the first mode and a second mode. In the first mode, the finger sensor 30 senses the biometrics characteristics of the finger F of the user to obtain a biometrics characteristic signal. The processing module 40 performs an enrollment or authentication procedure according to the biometrics characteristic signal. Therefore, the first mode pertains to the mode of sensing the fine characteristics of the finger F, and may be referred to as a biometrics identification sensing mode. In one example, the processing module 40 is a central processing unit (CPU) of the electronic device 100 capable of executing an application program and controlling operations of each element. The processing module 40 may be configured to enter the first mode only when a biometrics identification application program is executed according to the application program, such as an application program of a booting protection frame, executed therein. In order to make the user know the current mode, the processing module 40 may enable the display 20 to display a virtual finger image or dynamic image guide when executing the biometrics identification application program. It is to be noted that the audio indication may be provided to inform the user that the first mode is entered.

In the second mode, the finger sensor 30 senses a touch operation of the finger F of the user to obtain a touch signal, and the processing module 40 controls an operation of an operation system or an application program loaded into the processing module 40 according to the touch signal. Therefore, the second mode pertains to the mode of sensing whether the finger F touches the finger sensor or not, and may be referred to as a touch sensing mode. The touch operation comprises, but without limitation to, the direct contact, proximity, sliding, rotation, single click, double clicks or the like. The touch function may be the button or key function provided by a mobile phone or a tablet computer. So, in the second mode, the finger sensor 30 may function as a back key 92, a home key 91, a menu key 93 or a search key (not shown). In this embodiment, the finger sensor 30 executes the function of the Home key 91 in the second mode. That is, in the second mode, the finger sensor 30 senses the touch operation of the finger F of the user to obtain a touch signal, and the processing module 40 controls an operation of an operation system or an application program loaded into the processing module 40 according to the touch signal.

The biometrics characteristics comprise the fingerprint or vein image. In addition, the electronic device 100 may further comprise a speaker 50, a photographing lens 60 and a button 70. The speaker 50 may output the sound to indicate or guide the user to perform the associated operation. The photographing lens 60 can perform the photographing and video recording functions. The button 70 is electrically connected to the processing module 40 and can control the operation mode of the electronic device 100, such as the sleep mode, normal mode, airplane mode and/or on/off mode.

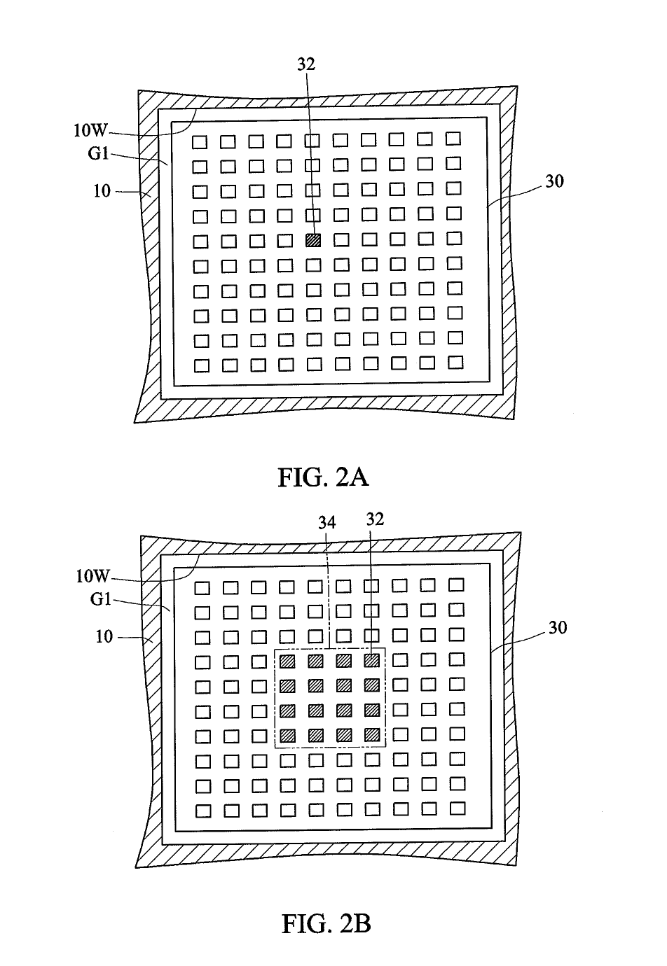

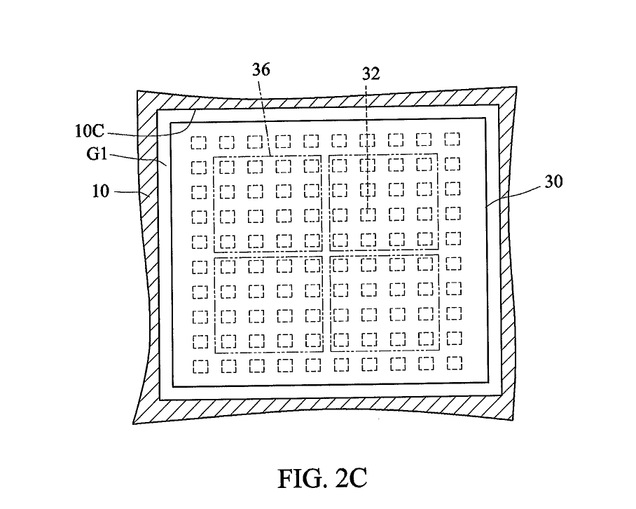

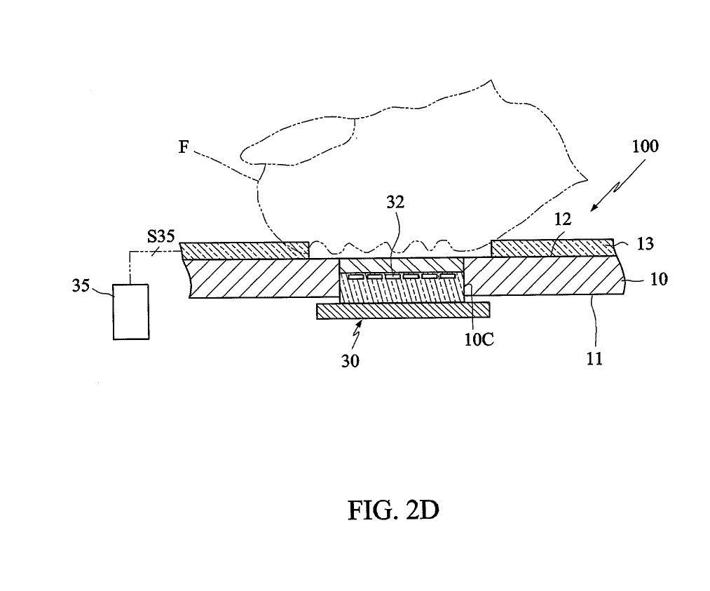

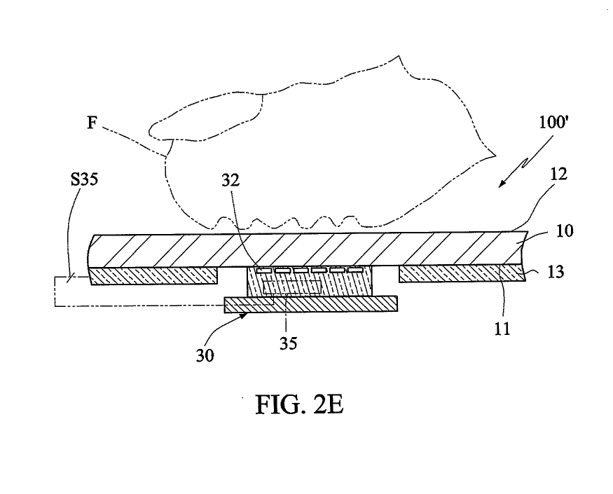

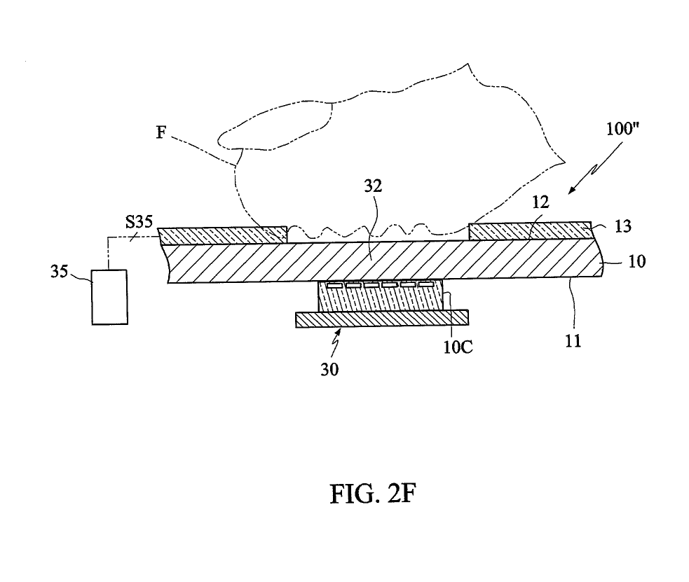

FIGS. 2A and 2B are partial top views showing examples of the electronic device 100 of FIG. 1. As shown in FIG. 2A, the finger sensor 30 comprises sensing members 32 arranged in a two-dimensional array. In the first mode, the sensing members 32 operate independently to sense the biometrics characteristics. In the second mode, one or multiple ones of the sensing members 32 operate to sense the touch operation. In FIG. 2A, only one sensing member 32, such as the hatched sensing member for detecting the finger's touch is in the detection state in the sleep mode of the electronic device 100, while the other sensing members 32 are in the disabled state to achieve the power-saving effect. In FIG. 2A, the finger sensor 30 is disposed in an opening 10W of the body 10, so that an exposed gap G1 is present between the body 10 and the finger sensor 30 to form a rectangular slot. Of course, considering the outlook, the sensor 30 may also be present in a modularized manner, and have the shape, which is inevitably rectangular and may also be circular or in the form of a rectangle with four right angles being chamfered. Also, the sensing members and the sensor in the drawings are only provided for the illustration only, and the real state thereof when being disposed in the electronic device may be invisible. The more frequently seen implementation is the outlook matching with the electronic device. For example, the outmost exposed layer of the sensor may be made of the wear-resisting material, such as glass, sapphire or the like. In order to facilitate the user in touching the sensor, the finger contact surface of the sensor and the neighboring body 10 are disposed on substantially the same plane, and have the same visual color design.

As shown in FIG. 2B, the processing module 40 in the second mode connects a portion of the sensing members 32 in parallel to form a single sensing member group 34 having sensing members operating dependently to sense the touch operation, wherein the processing module 40 can utilize transistor switches to implement the parallel or independent connection for the sensing members 32. It is to be noted that, in another example, all the sensing members 32 may be connected in parallel to form a single sensing member group. The so-called parallel connection comprises, but without limitation to, the physical parallel connection or the virtual parallel connection. The physical parallel connection can utilize control signals to switch the sensing members between the first mode and the second mode through the layout of wires and switches. The virtual parallel connection can make the processing module process the signals of all the sensing members through the software or firmware control method to switch between the first mode and the second mode. In another method, all the sensing members 32 within the range of the sensing member group 34 operate independently, and only the signals detected by the sensing members are statistically processed (because the ridge and valley of the fingerprint are present when the finger contacts with the sensor, some sensing members 32 are disposed in the valley region and have the weaker signals). It is to be noted that in order to satisfy the finger's fine texture detection, the size of the sensing member 32 is designed according to the resolution ranging from 300 to 1000 dpi.

FIG. 2C is a partial bottom view showing one example of the electronic device 100 of FIG. 1. As shown in FIG. 2C, the processing module 40 in the second mode connects a portion of the sensing members 32 in parallel to form multiple sensing member groups 36 to sense the touch operation. In another example, all the sensing members 32 may be connected in parallel to form a single sensing member group. It is to be noted that the finger sensor 30 is disposed in a cavity 10C of the body 10. The cavity 10C does not penetrate through the body 10.

FIG. 2D is a partial cross-sectional view showing the electronic device 100 of FIG. 2C. As shown in FIG. 2D, an upper surface 12 of the body 10 of the electronic device 100 is formed with a couple electrode 13 or couple electrodes 13, wherein a lower surface 11 of the body 10 is formed with a cavity 10C, and the dielectric constant of the material of the body 10 from the cavity 10C to the finger is higher than the dielectric constant of the other portion of the body 10. Thus, the material of the high dielectric constant can be utilized to amplify the coupled capacitance. A couple signal S35 is provided from a drive circuit 35 to the couple electrode 13 and directly coupled to the finger F, so that the sensing members 32 of the finger sensor 30 senses a biometrics characteristic (e.g., fingerprint) or touch message of the finger F in contact with the upper surface 12 of the body 10. The drive circuit 35 may be built in the finger sensor 30, and may also be disposed outside the finger sensor 30. It is to be noted that, in addition to the active finger sensor, a passive fingerprint sensor with the couple electrode 13 and the drive circuit 35 is also applicable to the invention.

FIG. 2E is a partial cross-sectional view showing another example of the electronic device 100′ of FIG. 2D. As shown in FIG. 2E, this electronic device 100′ is similar to that of FIG. 2D except that the finger sensor 30 is completely hidden below the body (e.g., the glass panel of the display) 10 and is disposed on the lower surface 11 of the body 10. That is, no gap between the finger sensor 30 and the opening of the body 10 is present so that the completely hidden effect is present. In addition, the couple electrode 13 is disposed on the lower surface 11 of the body 10, so that the couple signal S35 provided to the couple electrode 13 is indirectly coupled to the finger F. FIG. 2F is a partial cross-sectional view showing still another example of the electronic device 100″ of FIG. 2D. As shown in FIG. 2F, the electronic device 100″ is similar to that of FIG. 2E except that the couple electrode 13 is disposed on the upper surface 12 of the body 10. It is to be noted that the passive fingerprint sensor without the couple electrode 13 and the drive circuit 35 is also applicable to the invention.

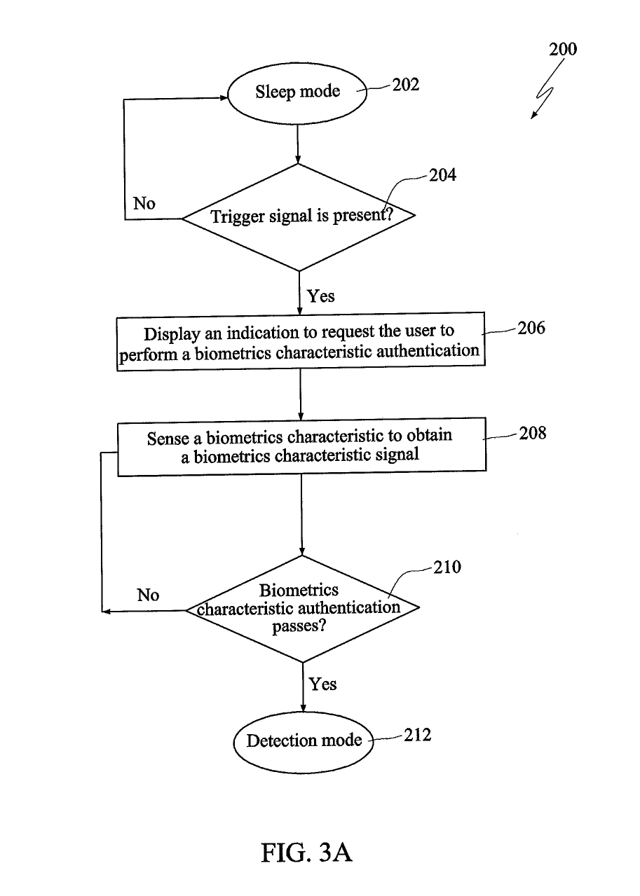

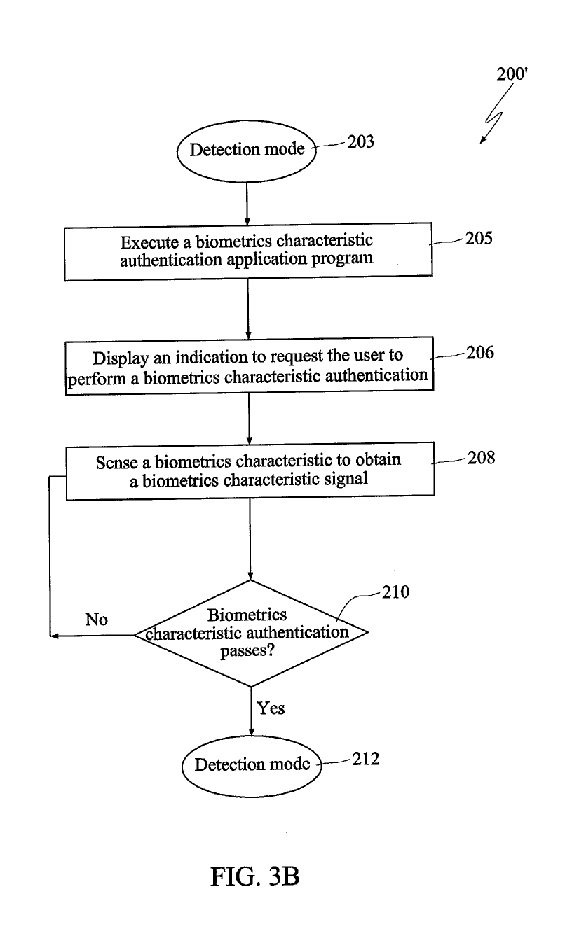

FIGS. 3A and 3B are flow charts showing two examples of the operating method of the electronic device according to the preferred embodiment of the invention. As shown in FIGS. 3A and 1, the operating method 200 of the electronic device comprises the following steps. In step 202, the electronic device 100 is in the sleep mode. In step 204, the processing module 40 continuously detects whether a trigger signal is generated or not. If the trigger signal is generated, then the processing module 40 receives the trigger signal and switches from the sleep mode to a biometrics characteristic authentication mode, and step 206 is executed. If no trigger signal is generated, then the electronic device 100 is continuously in the sleep mode. The trigger signal may be generated by the finger sensor 30, a trigger button 70 electrically connected to the processing module 40, or any other software or hardware trigger mechanism. In the biometrics characteristic authentication mode of the step 206, the display 20 displays an indication, which may comprise a graphic or text indication, to request the user to perform the biometrics characteristic authentication. Of course, the audio guiding method may be performed to guide the user. Then, in step 208, the finger sensor 30 senses the biometrics characteristic of the finger F of the user to obtain the biometrics characteristic signal. Next, in step 210, the processing module 40 performs the biometrics characteristic authentication according to the biometrics characteristic signal, and judges whether the biometrics characteristic authentication passes or succeeds. If the authentication passes, then step 212 is performed to enter a detection mode. In the detection mode, the finger sensor 30 senses the touch operation of the finger F of the user to obtain the touch signal. The processing module 40 controls the operation of the operation system or application program loaded into the processing module 40 according to the touch signal.

As shown in FIGS. 3B and 1, the operating method 200′ of the electronic device comprises the following steps. First, in step 203, the electronic device 100 is in the detection mode. Then, in step 205, the processing module 40 executes a biometrics characteristic authentication application program to enter a biometrics characteristic authentication mode, and steps 206 to 212 are performed. Because the steps 206 to 212 have been described hereinabove, detailed descriptions thereof will be omitted. This example is to describe the flow when the finger sensor 30 switches from the detection mode to the biometrics characteristic authentication mode, and then back to the detection mode. Therefore, in one example, the finger sensor 30 functions as a home key to sense the rough characteristics touch mode of the finger, and then functions as the sensor to sense the finger's fine characteristics (e.g., fingerprint, vein image, blood oxygen concentration or the like). In other words, the finger sensor 30 switches from the sensing mode with the low sensing resolution to the sensing mode with the high sensing resolution, and then from the sensing mode with the high sensing resolution back to the sensing mode with the low sensing resolution. In another example, a sensing mode (also referred to as a motion sensing mode) with a medium sensing resolution may be added to function to sense the finger's substantial profile or sense the finger's sliding behavior, such as the sliding direction, rotation detection, speed detection, or the like for the specific application program. In one example, the processing module 40 executes a biometrics characteristic application program to enter this motion sensing mode (the sensing resolution in the motion sensing mode is lower than that in the biometrics characteristic authentication mode, and higher than the sensing resolution in the detection mode) to provide the above-identified function. Therefore, the electronic device has at least three modes including the touch sensing mode, the biometrics identification sensing mode and the motion sensing mode. In still another example, the application program may be utilized to inform the user to touch a finger sensor. When the finger sensor senses the touch operation, the finger sensor immediately switches from the touch sensing mode to the biometrics identification sensing mode, so that the touch and fingerprint sensing modes are instantaneously switched, and the touch and fingerprint sensing operations can be verified smoothly upon the touch of the finger.

With the above-mentioned electronic device, the advanced and maximum effectiveness of the finger sensor can be obtained so that the finger sensor functions as the button or key. In addition, the combination of the button and the finger sensor also make the overall electronic device become more concise and beautiful.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An electronic device, comprising:
a body;
a display disposed on the body;
a finger sensor disposed on the body; and
a processing module, which is disposed on the body, is electrically connected to the finger sensor and the display, and cooperates with the display and the finger sensor to operate in a first mode and a second mode, wherein:
in the first mode, the finger sensor senses a biometrics characteristic of a finger of a user to obtain a biometrics characteristic signal, and the processing module performs an enrollment or authentication procedure according to the biometrics characteristic signal; and
in the second mode, the finger sensor senses a touch operation of the finger of the user to obtain a touch signal, and the processing module controls an operation of an operation system or an application program loaded into the processing module according to the touch signal.

2. The electronic device according to claim 1, wherein the finger sensor comprises sensing members arranged in a two-dimensional array, wherein:
in the first mode, the sensing members operate independently to sense the biometrics characteristic; and
in the second mode, one or multiples ones of the sensing members operate to sense the touch operation.

3. The electronic device according to claim 2, wherein in the second mode, the processing module connects all or a portion of the sensing members in parallel to form a single sensing member group to sense the touch operation.

4. The electronic device according to claim 2, wherein in the second mode, the processing module connects all or a portion of the sensing members in parallel to form multiple sensing member groups to sense the touch operation.

5. The electronic device according to claim 1, wherein the finger sensor is a sweep-type fingerprint sensor for sensing a fingerprint of the finger sweeping across the sweep-type fingerprint sensor in the first mode.

6. The electronic device according to claim 1, wherein the finger sensor is an area-type fingerprint sensor for sensing a fingerprint of the finger stationarily placed on the area-type fingerprint sensor in the first mode.

7. The electronic device according to claim 1, wherein the processing module enters the first mode only when executing a biometrics identification application program.

8. The electronic device according to claim 1 being a mobile phone or tablet computer, wherein in the second mode, the finger sensor functions as a back key, a home key, a menu key or a search key.

9. The electronic device according to claim 1, wherein the biometrics characteristic comprises a fingerprint or vein image.

10. The electronic device according to claim 1, wherein the finger sensor is disposed in an opening of the body.

11. The electronic device according to claim 1, wherein the finger sensor is disposed in a cavity of the body, and a dielectric constant of a material of the body from the cavity to the finger is higher than dielectric constants of other portions of the body.

12. The electronic device according to claim 1, wherein the finger sensor is disposed on a lower surface of the body and completely hidden below the body, a couple electrode is disposed on an upper surface of the body, a couple signal is provided to the couple electrode and directly coupled to the finger, so that the finger sensor senses the biometrics characteristic or a touch message of the finger in contact with the upper surface of the body.

13. The electronic device according to claim 1, wherein the finger sensor is disposed on a lower surface of the body and completely hidden below the body, a couple electrode is disposed on the lower surface of the body, and a couple signal is provided to the couple electrode and indirectly coupled to the finger, so that the finger sensor senses the biometrics characteristic or a touch message of the finger in contact with an upper surface of the body.

14. An operating method of an electronic device, the electronic device comprising a display, a finger sensor and a processing module, the processing module being electrically connected to the finger sensor and the display, the operating method comprising the steps of:
receiving a trigger signal by the processing module, and switching from a sleep mode to a biometrics characteristic authentication mode;
displaying an indication on the display to request a user to perform a biometrics characteristic authentication and utilize the finger sensor to sense a biometrics characteristic of a finger of the user to obtain a biometrics characteristic signal in the biometrics characteristic authentication mode, wherein the processing module performs the biometrics characteristic authentication according to the biometrics characteristic signal, and enters a detection mode after passing the biometrics characteristic authentication; and
sensing, by the finger sensor, a touch operation of the finger of the user to obtain a touch signal, and controlling, by the processing module, an operation of an operation system or an application program loaded into the processing module according to the touch signal in the detection mode.

15. The method according to claim 14, wherein the trigger signal is generated by the finger sensor.

16. The method according to claim 14, wherein the trigger signal is generated by a button electrically connected to the processing module.

17. An operating method of an electronic device, the electronic device comprising a display, a finger sensor and a processing module, the processing module being electrically connected to the finger sensor and the display, the operating method comprising the steps of:
executing a biometrics characteristic authentication application program by the processing module to enter a biometrics characteristic authentication mode;
utilizing the finger sensor to sense a biometrics characteristic of a finger of a user to obtain a biometrics characteristic signal in the biometrics characteristic authentication mode, wherein the processing module performs a biometrics characteristic authentication according to the biometrics characteristic signal, and leaves the biometrics characteristic authentication mode and enters a detection mode after passing the biometrics characteristic authentication; and
sensing, by the finger sensor, a touch operation of the finger of the user to obtain a touch signal, and controlling, by the processing module, an operation of an operation system or an application program loaded into the processing module according to the touch signal in the detection mode.

18. The method according to claim 17, further comprising the step of:
executing, by the processing module, a biometrics characteristic application program to enter a motion sensing mode, wherein a sensing resolution of the finger sensor in the motion sensing mode is lower than a sensing resolution of the finger sensor in the biometrics characteristic authentication mode, and is higher than a sensing resolution of the finger sensor in the detection mode.
